(19) United States
(12) Patent Application Publication
(10) Pub. No.: US 2026/0175567 A1
(43) Pub. Date: Jun. 25, 2026

(54) Liquid Ejecting Head

(71) Applicant: SEIKO EPSON CORPORATION, Tokyo (JP)

(72) Inventors: Ken YAMAGISHI, Shiojiri (JP); Kento NAWA, Shiojiri (JP)

(21) Appl. No.: 19/430,476

(22) Filed: Dec. 23, 2025

(30) Foreign Application Priority Data
Dec. 25, 2024 (JP) 2024-228843

(51) Int. Cl. B41J 2/045; B41J 2/14

(52) U.S. Cl. CPC B41J 2/04548; B41J 2/04563; B41J 2/04581; B41J 2/14233; B41J 2/1433; B41J 2002/14354; B41J 2002/14491

(57) ABSTRACT

A liquid ejecting head includes a piezoelectric substrate that includes a plurality of piezoelectric elements, a wiring substrate, and a flexible printed substrate configured to electrically couple the piezoelectric substrate and the wiring substrate, in which the flexible printed substrate includes a plurality of drive signal wirings configured to transmit drive signals for driving the plurality of piezoelectric elements, an analog signal wiring configured to transmit an analog signal, and a constant voltage wiring maintained at a constant voltage, and the constant voltage wiring is interposed between the drive signal wiring and the analog signal wiring in a first direction intersecting with a direction in which the constant voltage wiring is disposed.

The present application is based on, and claims priority from JP Application Serial Number 2024-228843, filed December 25, 2024, the disclosure of which is hereby incorporated by reference herein in its entirety.

### BACKGROUND

### 1. Technical Field

The present disclosure relates to a liquid ejecting head.

### 2. Related Art

A liquid ejecting apparatus including a liquid ejecting head for ejecting a liquid such as ink onto a medium such as printing paper is proposed in the related art. As the liquid ejecting head, a head that ejects a liquid filled in a pressure chamber from a nozzle by vibrating a vibration plate constituting a wall surface of the pressure chamber with a piezoelectric element is known.

In general, a piezoelectric element is provided corresponding to each of a plurality of nozzles. Each piezoelectric element is driven in response to a drive signal, and a predetermined amount of liquid is ejected from the corresponding nozzle at a predetermined timing. As a result, a dot is formed on the medium. The piezoelectric element is a capacitive load similar to a capacitor, from an electrical standpoint. Therefore, in order to operate the piezoelectric element of each nozzle, it is necessary to supply a sufficient current to the piezoelectric element.

Japanese Patent No. 7483318 discloses a liquid ejecting head that includes a plurality of nozzles arranged in a row of 300 or more per inch, and a wiring structure for stably driving each of the plurality of nozzles.

JP-A-2024-051474 discloses a technique for improving the ejection accuracy of a liquid ejecting head, in which a resistance wiring is disposed in the vicinity of a nozzle, and a drive signal for ejecting is corrected using an electric resistance value of the resistance wiring. The liquid ejecting head of the document includes a temperature information output circuit as an analysis portion and a control circuit. The temperature information output circuit outputs the temperature corresponding to the electric resistance value of the resistance wiring as an analog sensor, as a temperature information signal, which is an analog signal. The control circuit corrects a control signal based on the temperature information signal. The signal waveform of the drive signal is corrected based on the control signal.

In a liquid ejecting head having a high nozzle density, it is necessary to pay attention to prevent noise from being superimposed on an analog signal output from an analog sensor disposed in the vicinity of the nozzle when transmitting the analog signal to an analysis portion.

The present inventors have newly found a wiring design method that provides high signal transmission accuracy in an analog signal wiring for transmitting an analog signal.

### SUMMARY

According to an aspect of the present disclosure, there is provided a liquid ejecting head including a piezoelectric substrate that includes a plurality of piezoelectric elements, a wiring substrate, and a flexible printed substrate configured to electrically couple the piezoelectric substrate and the wiring substrate, in which the flexible printed substrate includes a plurality of drive signal wirings configured to transmit drive signals for driving the plurality of piezoelectric elements, an analog signal wiring configured to transmit an analog signal, and a constant voltage wiring maintained at a constant voltage, and the constant voltage wiring is interposed between the drive signal wiring and the analog signal wiring in a first direction intersecting with a direction in which the constant voltage wiring is disposed.

### BRIEF DESCRIPTION OF THE DRAWINGS

FIG. 1 is a schematic diagram illustrating a configuration of a liquid ejecting apparatus according to a first embodiment.

FIG. 2 is a diagram illustrating a functional configuration of the liquid ejecting apparatus illustrated in FIG. 1.

FIG. 3 is an exploded perspective view of a liquid ejecting head illustrated in FIG. 2.

FIG. 4 is a cross-sectional view illustrating a liquid ejecting module in FIG. 3.

FIG. 5 is an exploded perspective view of a head chip provided in the liquid ejecting module in FIG. 4.

FIG. 6 is a cross-sectional view illustrating a piezoelectric substrate in FIG. 5.

FIG. 7 is a cross-sectional view illustrating the piezoelectric substrate in FIG. 5.

FIG. 8 is a plan view of the piezoelectric substrate in FIG. 5.

FIG. 9 is a view illustrating a flexible printed substrate illustrated in FIG. 4.

FIG. 10 is a perspective view illustrating a part of the flexible printed substrate illustrated in FIG. 9.

FIG. 11 is a perspective view illustrating a part of the flexible printed substrate illustrated in FIG. 9.

FIG. 12 is a view illustrating a mounting region and the vicinity thereof in a state where the flexible printed substrate illustrated in FIG. 9 is not bent.

FIG. 13 is a view illustrating a coupling state between various wirings provided in the flexible printed substrate illustrated in FIG. 9 and various electrodes provided on the piezoelectric substrate.

### DESCRIPTION OF EMBODIMENTS

Hereinafter, preferred embodiments according to the present disclosure will be described with reference to the accompanying drawings. In the drawings, the dimension or scale of each portion is appropriately different from the actual dimension or scale, and some portions are schematically illustrated for easy understanding. In addition, the scope of the present disclosure is not limited to these embodiments unless it is noted in the following description that the present disclosure is particularly limited. In addition, the phrase “element β on element γ” is not limited to a configuration in which the element γ is in direct contact with the element β, and also includes a configuration in which the element γ is not in direct contact with the element β. The phrase "the element γ is equal to the element β" means that the element γ may be substantially equal to the element β, and includes manufacturing errors and the like.

### 1. First Embodiment

### 1-1. Overall Configuration of Liquid Ejecting Apparatus 100

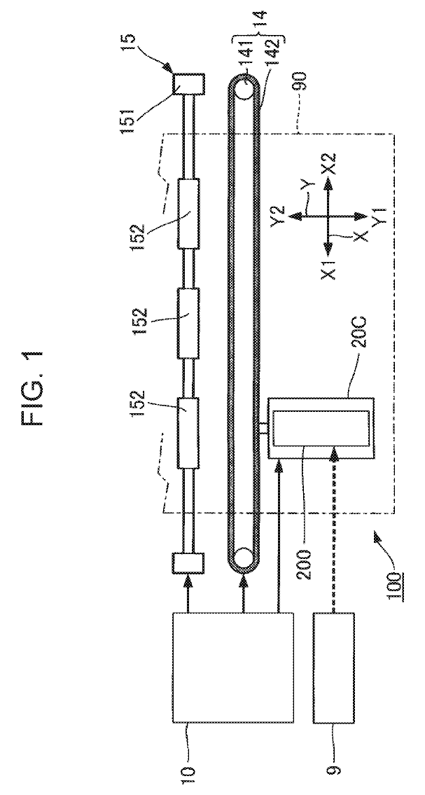

FIG. 1 is a schematic diagram illustrating a configuration of a liquid ejecting apparatus 100 according to a first embodiment. Hereinafter, for convenience of description, the description will be made by appropriately using an X axis, a Y axis, and a Z axis, which are orthogonal to one another. In addition, one direction along the X axis is referred to as an X1 direction, and a direction opposite to the X1 direction is referred to as an X2 direction. Similarly, one direction along the Y axis is referred to as a Y1 direction, and a direction opposite to the Y1 direction is referred to as a Y2 direction. One direction along the Z axis is referred to as a Z1 direction, and a direction opposite to the Z1 direction is referred to as a Z2 direction. Viewing in a direction along the Z axis will be referred to as a "plan view". The Z axis is typically a vertical axis. The Z2 direction is an upper side, and the Z1 direction is a lower side.

The liquid ejecting apparatus 100 in FIG. 1 is an ink jet type printing apparatus that ejects a liquid such as ink onto a medium 90. The liquid ejecting apparatus 100 is a serial head type. The medium 90 is typically printing paper, but a printing target of an arbitrary material such as a resin film or a cloth is used as the medium 90. In addition, a liquid container 9 that stores the liquid is installed in the liquid ejecting apparatus 100.

The liquid ejecting apparatus 100 includes a control unit 10, a medium transport mechanism 15, a moving mechanism 14, and a liquid ejecting head 200.

The control unit 10 includes, for example, one or a plurality of processing circuits such as a central processing unit (CPU) or a field programmable gate array (FPGA), and one or a plurality of storage circuits such as a semiconductor memory, and comprehensively controls each element of the liquid ejecting apparatus 100.

The medium transport mechanism 15 transports the medium 90 in a direction along the Y axis under the control of the control unit 10. The medium transport mechanism 15 includes a transport motor 151 and a plurality of transport rollers 152. The transport motor 151 operates based on the control of the control unit 10.

The moving mechanism 14 reciprocates a carriage 20C on which the liquid ejecting head 200 is mounted along the X axis under the control of the control unit 10. The moving mechanism 14 includes a carriage motor 141 and an endless belt 142. The carriage motor 141 operates based on the control of the control unit 10.

The liquid ejecting head 200 ejects the liquid supplied from the liquid container 9 from a plurality of nozzles onto the medium 90 under the control of the control unit 10. An image is formed on the surface of the medium 90 by ejecting the liquid onto the medium 90 by each liquid ejecting head 200 in parallel with the transport of the medium 90 by the medium transport mechanism 15 and the reciprocating motion of the carriage 20C by the moving mechanism 14.

The liquid ejecting apparatus 100 is a serial head type in which the liquid ejecting head 200 reciprocates above the medium 90. However, the liquid ejecting apparatus 100 may be a line head type in which the liquid ejecting head 200 is fixed.

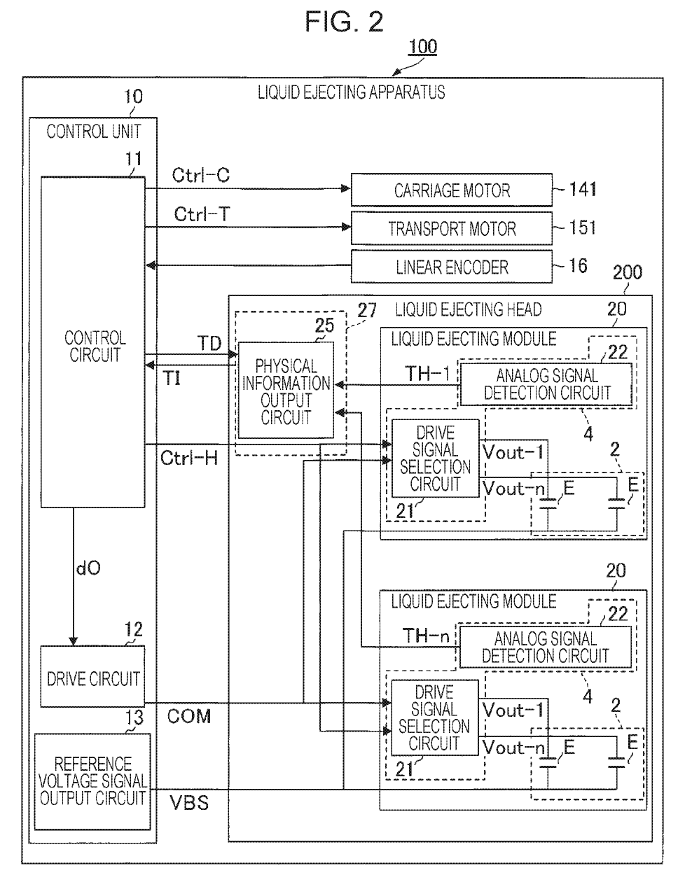

FIG. 2 is a diagram illustrating a functional configuration of the liquid ejecting apparatus 100 illustrated in FIG. 1.

The control unit 10 includes a control circuit 11, a drive circuit 12, and a reference voltage signal output circuit 13. An image information signal including image data or the like is input to the control circuit 11 from an external device, such as a host computer, that is coupled to the outside of the liquid ejecting apparatus 100 in a communicable manner. The control circuit 11 generates various signals for controlling the liquid ejecting apparatus 100 based on the image information signal, and outputs the signals to the corresponding configurations.

In addition to the image information signal, a detection signal based on the scanning position of the carriage 20C is input to the control circuit 11 from a linear encoder 16. The control circuit 11 obtains the scanning position of the liquid ejecting head 200 mounted on the carriage 20C based on the detection signal. The control circuit 11 generates a control signal Ctrl-C for controlling the movement of the liquid ejecting head 200 according to the scanning position of the liquid ejecting head 200, and outputs the control signal Ctrl-C to the carriage motor 141. In addition, the control circuit 11 generates a control signal Ctrl-T for controlling the transport of the medium 90, and outputs the control signal Ctrl-T to the transport motor 151.

The control circuit 11 generates and outputs a control signal Ctrl-H for controlling the liquid ejecting head 200 based on the above-described image information signal and the scanning position of the liquid ejecting head 200. The control signal Ctrl-H includes a head control signal, a change signal, a latch signal, and a clock signal.

The control circuit 11 generates a physical information request signal TD for acquiring physical information such as the temperature, humidity, and pressure of the liquid ejecting head 200 at a predetermined timing, and outputs the physical information request signal TD to the liquid ejecting head 200. In addition, a physical information signal TI output by the liquid ejecting head 200 in response to the physical information request signal TD is input to the control circuit 11. Furthermore, the control circuit 11 corrects the control signals Ctrl-H, Ctrl-C, and Ctrl-T based on the physical information signal TI. In addition, the control circuit 11 may stop the operation of the liquid ejecting apparatus 100 based on the physical information signal TI.

The control circuit 11 outputs a basic drive signal dO, which is a digital signal, to the drive circuit 12. The drive circuit 12 generates a drive signal COM by converting and amplifying the basic drive signal dO into an analog signal, and outputs the drive signal COM to the liquid ejecting head 200.

The reference voltage signal output circuit 13 generates a reference voltage signal VBS and outputs the reference voltage signal VBS to the liquid ejecting head 200. The reference voltage signal VBS is a constant potential signal that is a reference for driving a piezoelectric element E described later provided in the liquid ejecting head 200. For example, the reference voltage signal VBS is a ground potential or a DC voltage signal having a constant potential.

The liquid ejecting head 200 includes liquid ejecting modules 20-1 to 20-n and a physical information output circuit 25. In addition, each of the liquid ejecting modules 20-1 to 20-n includes a drive signal selection circuit 21, an analog signal detection circuit 22, and piezoelectric elements E-1 to E-m.

The control signal Ctrl-H, the drive signal COM, and the reference voltage signal VBS are input to the liquid ejecting modules 20-1 to 20-n. Specifically, the control signal Ctrl-H and the drive signal COM are input to the drive signal selection circuit 21. The drive signal selection circuit 21 generates drive signals Vout-1 to Vout-m by selecting or not selecting the signal waveforms of the drive signal COM based on the control signal Ctrl-H. The drive signal Vout-1 corresponds to the piezoelectric element E-1, and the drive signal Vout-m corresponds to the piezoelectric element E-m. The drive signal selection circuit 21 individually inputs the drive signals Vout-1 to Vout-m to one end of the corresponding piezoelectric elements E-1 to E-m. In addition, the reference voltage signal VBS is commonly input to the other ends of the piezoelectric elements E-1 to E-m. The piezoelectric elements E-1 to E-m are driven by a potential difference between the drive signals Vout-1 to Vout-m and the reference voltage signal VBS. An amount of liquid according to the driving of each of the piezoelectric elements E-1 to E-m is ejected. The symbols of n and m represent natural numbers.

The liquid ejecting modules 20-1 to 20-n all have the same configuration, and may be referred to as a liquid ejecting module 20 when it is not necessary to distinguish the liquid ejecting modules. The piezoelectric elements E-1 to E-m all have the same configuration, and may be referred to as a piezoelectric element E when it is not necessary to distinguish the piezoelectric elements. The drive signals Vout-1 to Vout-m may be referred to as a drive signal Vout corresponding to the piezoelectric element E.

The analog signal detection circuit 22 detects analog signals TH-1 to TH-n corresponding to physical information such as the temperature, humidity, and pressure of the liquid ejecting modules 20-1 to 20-n, and outputs the analog signals to the physical information output circuit 25. That is, the analog signal detection circuit 22 is a physical information detection portion that detects physical information such as the temperature, humidity, and pressure of the liquid ejecting module 20. Therefore, for example, when the physical information is temperature, the analog signal detection circuit 22 corresponds to a “temperature detection portion” that detects the temperature of a pressure chamber C1 of the liquid ejecting module 20 described later.

When the liquid ejecting modules 20-1 to 20-n are not distinguished, the signal detected by the analog signal detection circuit 22 is referred to as an analog signal TH.

The analog signals TH-1 to TH-n and the physical information request signal TD are input to the physical information output circuit 25. The physical information output circuit 25 amplifies and stores each of the analog signals TH-1 to TH-n. The physical information output circuit 25 outputs, as the physical information signal TI, a corresponding signal among the signals obtained by amplifying each of the analog signals TH-1 to TH-n stored in response to the physical information request signal TD. The physical information output circuit 25 includes an amplifier circuit that amplifies the analog signals TH-1 to TH-n, a processor such as a microcomputer that outputs the physical information signal TI, and a storage circuit that stores the analog signals TH-1 to TH-n.

### 1-2. Liquid Ejecting Head 200

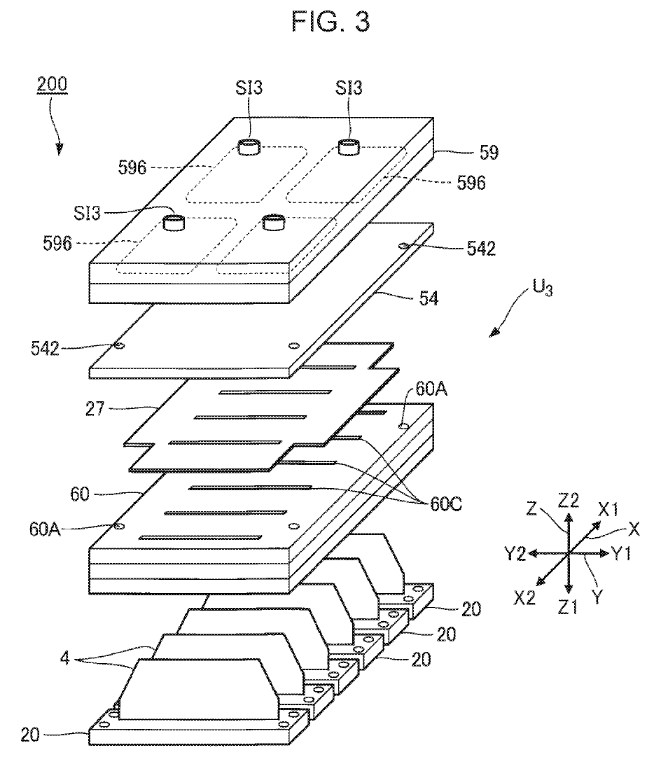

FIG. 3 is an exploded perspective view of the liquid ejecting head 200 illustrated in FIG. 2. The liquid ejecting head 200 illustrated in FIG. 3 includes a filter portion 59, a communication member 54, a wiring substrate 27, a liquid distribution portion 60, and a plurality of liquid ejecting modules 20. The filter portion 59, the communication member 54, the wiring substrate 27, the liquid distribution portion 60, and the plurality of liquid ejecting modules 20 are arranged in this order in the Z1 direction.

In the example illustrated in the drawing, the plurality of liquid ejecting modules 20 are six liquid ejecting modules 20. The plurality of liquid ejecting modules 20 are spaced apart from each other and are arranged in the direction along the X axis. Each liquid ejecting module 20 includes a flexible printed substrate 4.

The filter portion 59 is an element that removes air bubbles and foreign substances contained in the liquid supplied from the liquid container 9. The filter portion 59 is a flat plate material made of a resin material. In addition, four filters 596 are provided in the filter portion 59 according to, for example, the type of liquid. In addition, the filter portion 59 is provided with four supply ports SI3 for supplying the liquid from the liquid container 9 to the filter portion 59.

The communication member 54 is a flat plate material made of an elastic material. A plurality of through-holes 542 through which the liquid from the filter portion 59 flows are formed in the communication member 54.

The wiring substrate 27 is a substrate on which wiring for transmitting a drive signal or a power supply voltage to each liquid ejecting module 20 is formed. The wiring substrate 27 is commonly provided for the plurality of liquid ejecting modules 20. For example, the wiring substrate 27 is mounted with the physical information output circuit 25 in FIG. 2. In addition, a coupling terminal (not illustrated) to which the flexible printed substrate 4 provided in each liquid ejecting module 20 is electrically coupled is formed in the wiring substrate 27, and the wiring substrate 27 and the flexible printed substrate 4 are electrically coupled.

The liquid distribution portion 60 is a member that distributes the liquid supplied through each through-hole 542 of the communication member 54 to each liquid ejecting module 20. The liquid distribution portion 60 includes a stack of a plurality of flat plate members. The liquid distribution portion 60 is made of a resin material. In addition, the liquid distribution portion 60 is provided with a through-hole 60C through which the flexible printed substrate 4 is inserted.

The liquid ejecting head 200 in FIG. 3 is an example, and any element may be further added to the liquid ejecting head 200 or may be omitted. For example, a holder 29 and a distribution flow path member 28 may be integrally configured. In addition, the disposition relationship of each element of the liquid ejecting head 200 is not limited to the example in FIG. 3. For example, the wiring substrate 27 may be located on the side of the plurality of liquid ejecting modules 20.

### 1-3. Liquid Ejecting Module 20

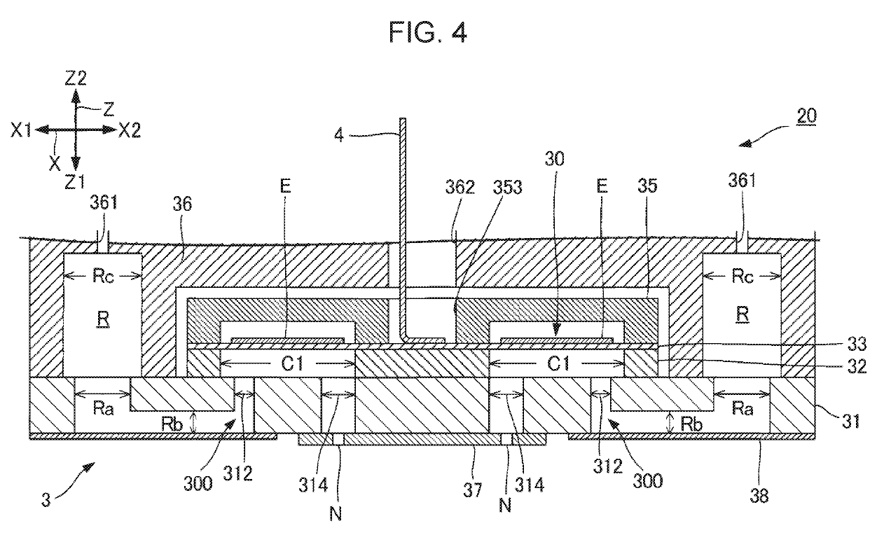

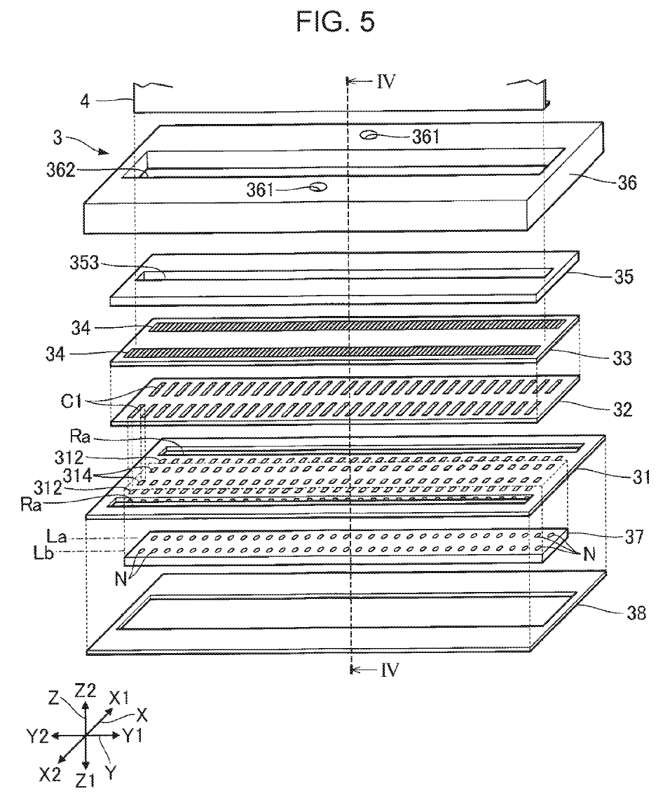

FIG. 4 is a cross-sectional view illustrating the liquid ejecting module 20 in FIG. 3. FIG. 5 is an exploded perspective view of the head chip 3 provided in the liquid ejecting module 20 in FIG. 4. As described above, the liquid ejecting module 20 includes the head chip 3 and the flexible printed substrate 4.

As illustrated in FIG. 5, the head chip 3 of the liquid ejecting module 20 includes a plurality of nozzles N arranged along the Y axis. The plurality of nozzles N are divided into a first nozzle row La and a second nozzle row Lb arranged in parallel with each other at intervals along the X axis. Each of the first nozzle row La and the second nozzle row Lb is a set of a plurality of nozzles N arranged linearly along the Y axis. In the following description, the elements corresponding to the first nozzle row La will be mainly described, and the description of the elements corresponding to the second nozzle row Lb will be omitted as appropriate.

As illustrated in FIGS. 3 and 4, the head chip 3 includes a flow path forming substrate 31, a pressure chamber substrate 32, a vibration plate 33, a nozzle substrate 37, a vibration absorber 38, a plurality of piezoelectric elements E, a sealing body 35, and a flow path housing portion 36. Each of the flow path forming substrate 31, the pressure chamber substrate 32, the vibration plate 33, the nozzle substrate 37, the vibration absorber 38, the sealing body 35, and the flow path housing portion 36 is a long plate-shaped member along the Y axis. In addition, the nozzle substrate 37, the flow path forming substrate 31, the pressure chamber substrate 32, the vibration plate 33, and the sealing body 35 are arranged in this order in the Z2 direction. In addition, the vibration plate 33 and the plurality of piezoelectric elements E constitute a piezoelectric substrate 30.

The nozzle substrate 37 is a plate-shaped member in which the plurality of nozzles N are formed. The nozzle substrate 37 includes the first nozzle row La and the second nozzle row Lb.

The flow path forming substrate 31 forms a flow path through which the liquid flows. Specifically, a space Ra, a relay liquid chamber Rb, a plurality of supply flow paths 312, and a plurality of communication flow paths 314 are formed in the flow path forming substrate 31. Each of the supply flow paths 312 and the communication flow paths 314 is a through-hole formed for each nozzle N. Each of the communication flow paths 314 overlaps with the corresponding one nozzle N in plan view when viewed from the Z1 direction. The relay liquid chamber Rb is a long space formed along the Y axis over the plurality of nozzles N, and allows the space Ra and the plurality of supply flow paths 312 to communicate with each other.

The pressure chamber substrate 32 is coupled to the piezoelectric substrate 30. The pressure chamber substrate 32 is provided with a pressure chamber C1 whose volume changes in response to deformation of the piezoelectric substrate 30. The liquid ejected from the nozzle N is stored in the pressure chamber C1. The pressure chamber C1 is a space located between the nozzle substrate 37 and the vibration plate 33 and formed by an inner wall surface of the pressure chamber substrate 32. The pressure chamber C1 is formed for each nozzle N. The pressure chamber C1 communicates with the nozzle N via the communication flow path 314 and communicates with the space Ra via the supply flow path 312 and the relay liquid chamber Rb.

The vibration plate 33 of the piezoelectric substrate 30 is coupled to the surface of the pressure chamber substrate 32 opposite to the flow path forming substrate 31. The vibration plate 33 is disposed on the pressure chamber C1 and is elastically deformable. The vibration plate 33 vibrates by driving the piezoelectric element E.

The piezoelectric element E is formed above the surface of the vibration plate 33 opposite to the pressure chamber C1. The piezoelectric element E is provided for each pressure chamber C1. The piezoelectric element E is a drive element that is driven by applying a drive signal, and applies pressure to the liquid in the pressure chamber C1.

The sealing body 35 is a structure that protects the plurality of piezoelectric elements E and reinforces the mechanical strength of the pressure chamber substrate 32 and the vibration plate 33. A recess on the surface facing the vibration plate 33 is formed in the sealing body 35. A plurality of piezoelectric elements E are accommodated inside the recess. In addition, the sealing body 35 has a space 353 through which the flexible printed substrate 4 is inserted.

In addition, the vibration absorber 38 is bonded to the surface of the flow path forming substrate 31 in the Z1 direction, for example, with an adhesive. The vibration absorber 38 is a flexible film that forms a wall surface of the space Ra.

The flow path housing portion 36 is bonded to the flow path forming substrate 31 by, for example, an adhesive. The flow path housing portion 36 is a case for storing the liquid supplied to the plurality of pressure chambers C1. A space Rc, a supply port 361, and a space 362 are formed in the flow path housing portion 36. The supply port 361 is a pipeline through which the liquid is supplied from the liquid container 9 via the distribution flow path member 28, and communicates with the space Rc. The space Rc communicates with the space Ra of the flow path forming substrate 31. The space including the space Rc and the space Ra functions as a liquid storage chamber R that stores the liquid supplied to the plurality of pressure chambers C1. The space 362 overlaps with the space 353 of the sealing body 35 in plan view. The flexible printed substrate 4 is inserted into the space 353 and the space 362.

The flexible printed substrate 4 is coupled to the vibration plate 33. The flexible printed substrate 4 electrically couples the piezoelectric substrate 30 and the wiring substrate 27. The flexible printed substrate 4 is a mounting component in which a plurality of wirings are formed. For example, the flexible printed substrate 4 is a flexible circuit substrate, such as a flexible printed circuit (FPC) or a chip on film (COF). The flexible printed substrate 4 is mounted with the drive signal selection circuit 21 in FIG. 2.

In the liquid ejecting module 20, when the piezoelectric element E is bent and deformed by applying a voltage, the vibration plate 33 is bent and deformed, that is, vibrates in a direction in which the volume of the pressure chamber C1 is reduced. As a result, the pressure of the pressure chamber C1 changes, and the liquid in the pressure chamber C1 is ejected from the nozzle N.

In addition, the liquid ejecting module 20 includes all the elements illustrated in FIGS. 4 and 5, but the constituent elements of the liquid ejecting module 20 may not include all the elements, and may further include additional elements.

### 1-4. Piezoelectric Substrate 30

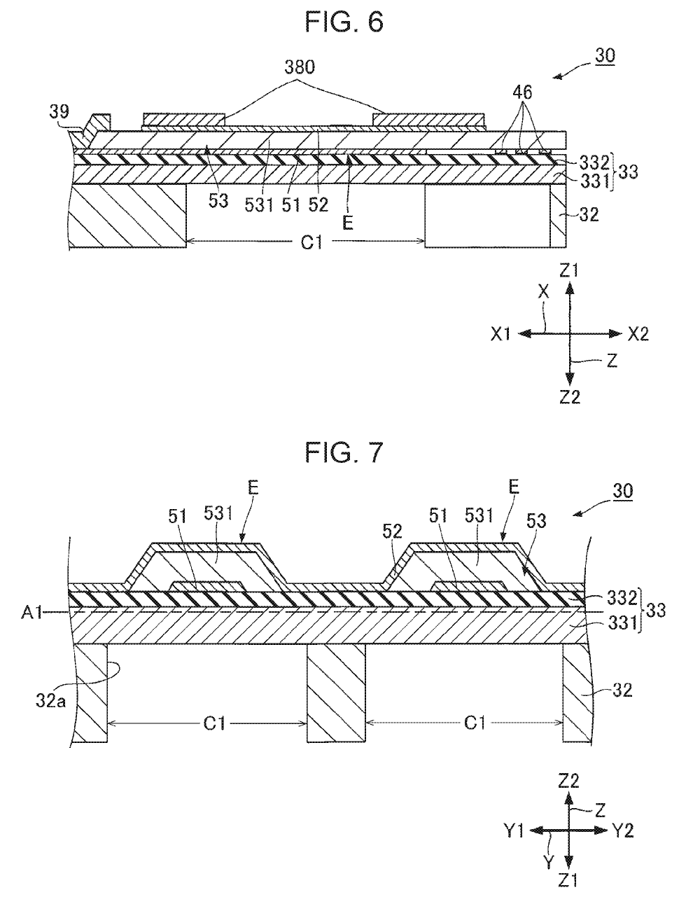

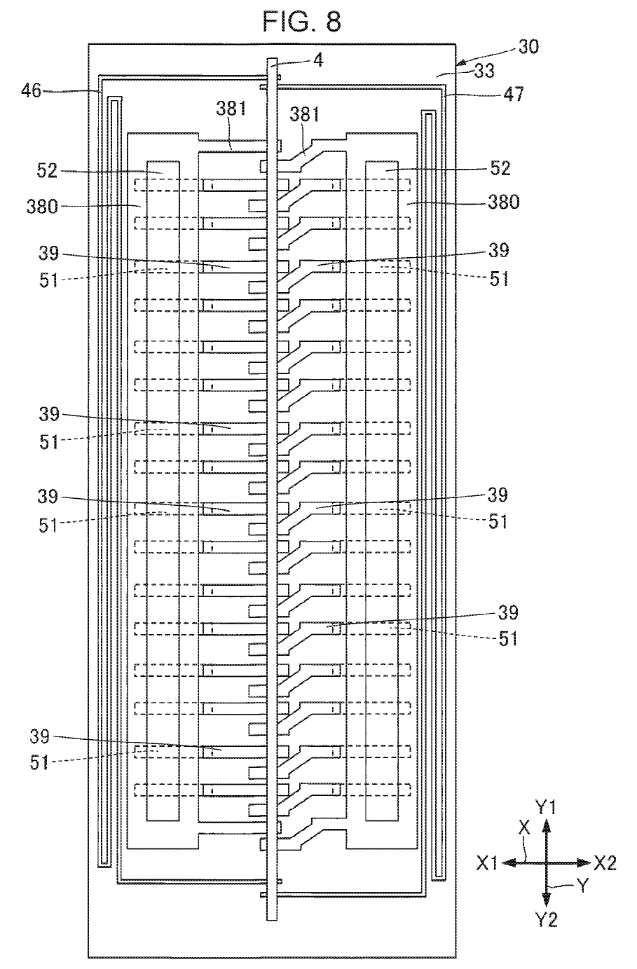

Each of FIGS. 6 and 7 is a cross-sectional view illustrating the piezoelectric substrate 30 in FIG. 5. FIG. 8 is a plan view of the piezoelectric substrate 30 in FIG. 5.

In the examples in FIGS. 6 and 7, the vibration plate 33 of the piezoelectric substrate 30 includes a stack having a first layer 331 and a second layer 332. The first layer 331 is in contact with the pressure chamber substrate 32. The second layer 332 is made of an insulating material such as zirconium oxide (ZrOₓ). For example, the first layer 331 is formed by thermally oxidizing a part of the pressure chamber substrate 32. The vibration plate 33 may include one layer or may include three or more layers.

The piezoelectric element E mainly includes an individual electrode 51, a piezoelectric layer 53, and a common electrode 52. The individual electrode 51, the piezoelectric layer 53, and the common electrode 52 are stacked in a direction along the Z axis, which is the stacking direction. In addition, the piezoelectric layer 53 has a plurality of piezoelectric portions 531. In FIG. 8, the piezoelectric layer 53 is not illustrated.

The individual electrode 51 is provided above the vibration plate 33. The individual electrode 51 is an individual electrode provided for each piezoelectric element E. The drive signal Vout is applied to the individual electrode 51. A plurality of individual electrodes 51 are arranged along the Y axis at intervals from each other. The individual electrode 51 contains a conductive material such as metal.

The piezoelectric layer 53 is provided above the individual electrode 51. For example, the piezoelectric layer 53 is a strip-shaped piezoelectric body film that is continuous over the plurality of piezoelectric elements E along the Y axis. For example, the piezoelectric layer 53 has a strip-shape extending along the Y axis and is separated for each piezoelectric element E by forming a plurality of notches. Since the plurality of notches are formed, the piezoelectric layer 53 has a plurality of piezoelectric portions 531. The plurality of individual electrodes 51 described above are provided to correspond to the plurality of piezoelectric portions 531.

Examples of the piezoelectric material include lead titanate (PbTiO₃), lead zirconate titanate (PZT:Pb(Zr, Ti)O₃), lead zirconate (PbZrO₃), lead lanthanum titanate ((Pb, La), TiO₃), lead lanthanum titanate zirconate ((Pb, La)(Zr, Ti)O₃), lead zirconate niobate titanate (Pb(Zr, Ti, Nb)O₃), and lead magnesium niobate zirconate titanate (Pb(Zr, Ti)(Mg, Nb)O₃).

The common electrode 52 is provided above the piezoelectric layer 53. The common electrode 52 is a strip-shaped common electrode extending along the Y axis to be continuous over the plurality of piezoelectric elements E. The common electrode 52 is shared by the plurality of piezoelectric portions 531 described above. The reference voltage signal VBS is applied to the common electrode 52. The common electrode 52 contains a conductive material such as metal.

A voltage corresponding to a difference between the reference voltage signal VBS applied to the common electrode 52 and the drive signal Vout corresponding to the ejection amount supplied to the individual electrode 51 is applied to the piezoelectric portion 531. When a voltage is applied between the individual electrode 51 and the common electrode 52, the piezoelectric portion 531 is deformed, and thus the piezoelectric element E is bent and deformed, that is, vibrates.

In addition, a weight portion 380 is provided in contact with the common electrode 52 above the common electrode 52. As illustrated in FIG. 8, the weight portion 380 has a quadrangular frame shape. The weight portion 380 functions as a weight for preventing excessive vibration of the vibration plate 33. In addition, a coupling electrode 381 is coupled to the weight portion 380. The coupling electrode 381 is coupled to the flexible printed substrate 4. The reference voltage signal VBS is applied to the common electrode 52 described above via the coupling electrode 381 and the weight portion 380. For example, the weight portion 380 contains a metal such as gold.

In addition, as illustrated in FIGS. 6 and 8, a coupling electrode 39 is coupled to each of the individual electrodes 51 described above. The coupling electrode 39 is coupled to the flexible printed substrate 4. The drive signal Vout is applied to the individual electrode 51 described above via the coupling electrode 39. For example, the coupling electrode 39 contains a metal such as gold.

In the examples illustrated in FIGS. 6 and 7, the individual electrode 51 is provided below the piezoelectric layer 53, and the common electrode 52 is provided above the piezoelectric layer 53. However, the common electrode 52 may be provided below the piezoelectric layer 53, and the individual electrode 51 may be provided above the piezoelectric layer 53.

### 1-5. Flexible Printed Substrate 4

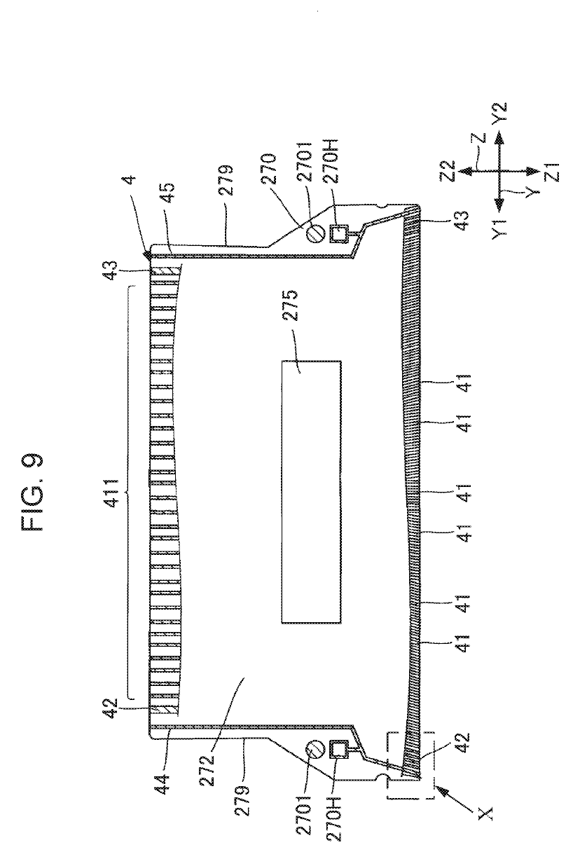

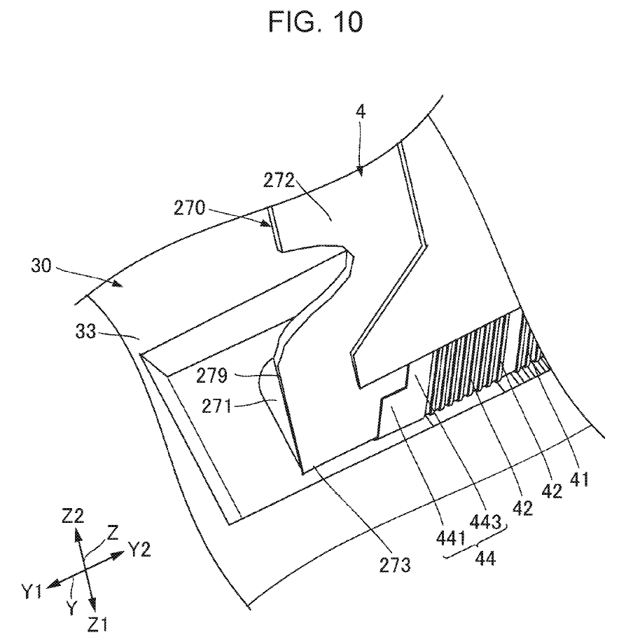

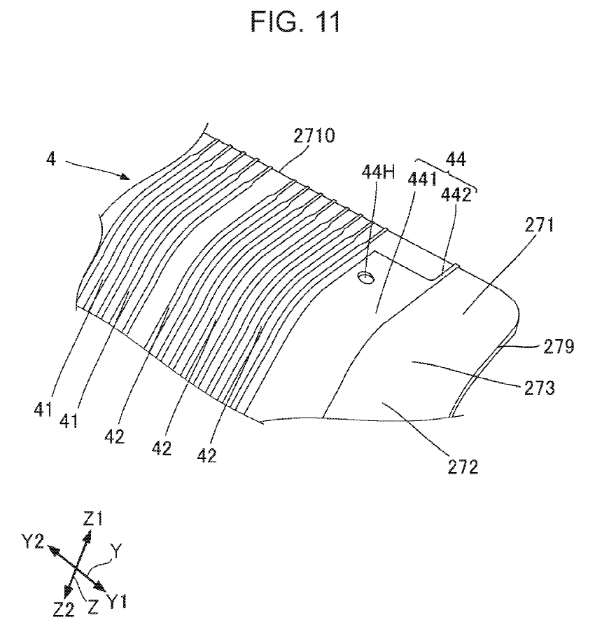

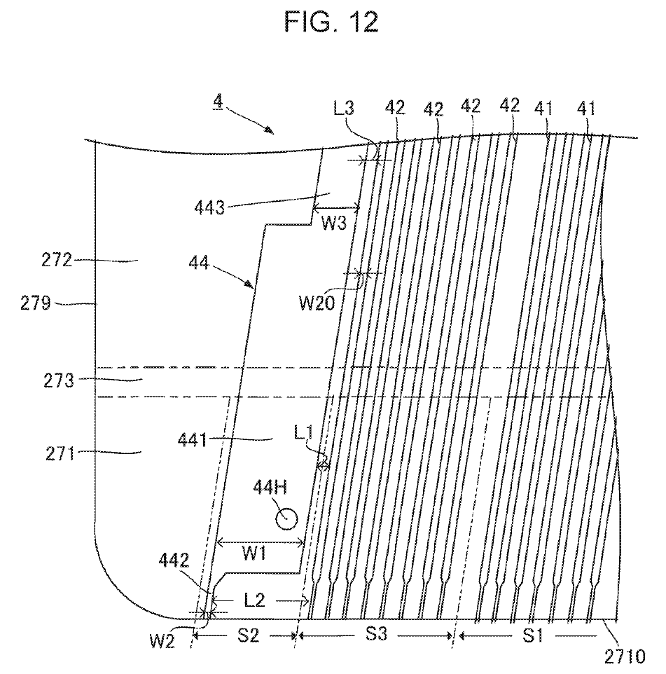

FIG. 9 is a view illustrating the flexible printed substrate 4 illustrated in FIG. 4. FIG. 10 is a perspective view illustrating a part of the flexible printed substrate 4 illustrated in FIG. 9, and is an enlarged view of a region X in FIG. 9. FIG. 11 is a view illustrating the mounting region 271 of the flexible printed substrate 4 illustrated in FIG. 9.

For example, the length of the flexible printed substrate 4 along the Y axis is substantially the same as the length from one end to the other end of the first nozzle row La. As illustrated in FIG. 4, a part of the flexible printed substrate 4 is coupled to the piezoelectric substrate 30, and the remaining part extends from the piezoelectric substrate 30 in the Z2 direction. As illustrated in FIG. 10, the flexible printed substrate 4 has a mounting region 271, a non-mounting region 272, and a curved portion 273. In addition, the flexible printed substrate 4 has a region coupled to the wiring substrate 27 at an end portion in the Z2 direction.

The mounting region 271 is a portion coupled to the piezoelectric substrate 30 and is a portion extending in the X-Y plane. The non-mounting region 272 is a portion that is not directly coupled to the piezoelectric substrate 30. The non-mounting region 272 is a portion extending in the Y-Z plane, and is a portion extending from the piezoelectric substrate 30 in the Z1 direction. The non-mounting region 272 is provided with a mounting component 275 illustrated in FIG. 9. For example, the drive signal selection circuit 21 and the analog signal detection circuit 22 in FIG. 2 are mounted on the mounting component 275. In addition, as illustrated in FIG. 10, the curved portion 273 is a boundary portion between the mounting region 271 and the non-mounting region 272. The curved portion 273 is a portion that is bent at approximately 90 degrees so that the flexible printed substrate 4 is curved.

The flexible printed substrate 4 includes a base material 270, a plurality of wirings 411, a plurality of drive signal wirings 41, a plurality of constant voltage wirings 42, a plurality of second constant voltage wirings 43, an analog signal wiring 44, a second analog signal wiring 45, and the mounting component 275. In FIG. 9, a part of various wirings provided in the flexible printed substrate 4 is illustrated, and the illustration of the vicinity of the mounting component 275 in the various wirings is omitted because the illustration is dense and complicates understanding.

The flexible printed substrate 4 may not have the mounting component 275. In this case, the drive signal selection circuit 21 and the analog signal detection circuit 22 are provided on the wiring substrate 27 to which one end of the flexible printed substrate 4 is coupled or anothersubstrate. In addition, in this case, the plurality of drive signal wirings 41 are electrically coupled to the wiring substrate 27.

The base material 270 is an insulator made of a resin such as polyimide. The base material 270 is a flexible film-like member. The plurality of drive signal wirings 41, the plurality of constant voltage wirings 42, the plurality of second constant voltage wirings 43, the analog signal wiring 44, and the second analog signal wiring 45 are formed on the base material 270. In addition, the wirings are covered with an insulator made of a resin such as polyimide in the non-mounting region 272. A direction in which each of the plurality of drive signal wirings 41, the plurality of constant voltage wirings 42, the plurality of second constant voltage wirings 43, the analog signal wiring 44, and the second analog signal wiring 45 is disposed is substantially the same direction, and is substantially a direction along the Z axis.

The plurality of wirings 411 are located in the Z2 direction with respect to the plurality of drive signal wirings 41. The plurality of wirings 411 are located at the center part of the base material 270 in the Y axis. The plurality of wirings 411 are spaced apart from each other and are arranged along the Y axis.

The plurality of wirings 411 are input-side wirings for coupling the wiring substrate 27 and the mounting component 275 to each other and inputting an input signal (for example, the drive signal COM, the latch signal, and the clock signal) to the mounting component 275. In addition, the plurality of wirings 411 may include wirings used as various configuration power supply voltages of the mounting component 275 and the liquid ejecting module 20.

The plurality of drive signal wirings 41 are located in the Z1 direction on the base material 270 and are provided at the center part of the base material 270 in the Y axis. The plurality of drive signal wirings 41 are spaced apart from each other and are arranged along the Y axis. The direction along the Y axis corresponds to a "first direction".

The plurality of drive signal wirings 41 are output-side wirings coupled to the mounting component 275 and for sending the drive signal Vout to the plurality of piezoelectric elements E. The plurality of drive signal wirings 41 correspond to the plurality of individual electrodes 51 on a one-to-one basis.

The constant voltage wiring 42 and the second constant voltage wiring 43 are located on the outside of the base material 270 with respect to the plurality of drive signal wirings 41 on the Y axis, and are disposed to interpose a group of the plurality of drive signal wirings 41 on the Y axis. In addition, the constant voltage wiring 42 and the second constant voltage wiring 43 are disposed so as to interpose a group of the plurality of wirings 411 in the Y axis direction.

The constant voltage wiring 42 and the second constant voltage wiring 43 are not coupled to the mounting component 275, and are disposed to couple the input side located in the Z2 direction of the flexible printed substrate 4 to the output side located in the Z1 direction. The constant voltage wiring 42 and the second constant voltage wiring 43 are one wiring in the input side and the non-mounting region 272 located in the Z2 direction, and are divided into a plurality of wirings in the mounting region 271. For example, the constant voltage wiring 42 and the second constant voltage wiring 43 are divided into eight wirings in the mounting region 271. The plurality of divided constant voltage wirings 42 and the plurality of second constant voltage wirings 43 are spaced apart from each other and are arranged along the Y axis.

The constant voltage wiring 42 and the second constant voltage wiring 43 are divided into a plurality of wirings in the mounting region 271, so that the surface area to which the adhesive is applied can be increased when the plurality of wirings are coupled. As a result, the flexible printed substrate 4 is unlikely to be peeled off from the piezoelectric substrate 30, and it is possible to prevent disconnection of the constant voltage wiring 42 and the second constant voltage wiring 43.

In addition, since the constant voltage wiring 42 and the second constant voltage wiring 43 are divided into a plurality of wirings in the mounting region 271, even when a positional displacement occurs when coupling to the coupling electrode 381 of the piezoelectric substrate 30 in the mounting region 271, poor contact can be prevented.

The width of one constant voltage wiring 42 in the mounting region 271 and the width of one second constant voltage wiring 43 may be equal to the width of the drive signal wiring 41. In addition, the distance between the plurality of constant voltage wirings 42 in the mounting region 271 and the distance between the plurality of second constant voltage wirings 43 may be equal to the distance between the plurality of drive signal wirings 41. In this case, the surface area to which the adhesive is applied in the constant voltage wiring 42, the second constant voltage wiring 43, and the drive signal wiring 41 are equal to each other, and variations in adhesion between the wirings can be prevented.

In the present description, the constant voltage wiring 42 and the second constant voltage wiring 43 in the mounting region 271 may be expressed as a plurality of constant voltage wirings 42 and a plurality of second constant voltage wirings 43.

The number of the constant voltage wirings 42 and the second constant voltage wirings 43 in the mounting region 271 is not limited to eight, and may be one or other than eight. The plurality of constant voltage wirings 42 and the plurality of second constant voltage wirings 43 may be formed from the mounting region 271 to the non-mounting region 272. In addition, the constant voltage wiring 42 and the second constant voltage wiring 43 may be divided into a plurality of wirings on the input side located in the Z2 direction.

In addition, each of the widths of the constant voltage wiring 42 and the second constant voltage wiring 43 in the mounting region 271 and the distance between the wirings may be set to any value.

Each of the constant voltage wiring 42 and the second constant voltage wiring 43 is maintained at a constant voltage. The reference voltage signal VBS is applied to each of the constant voltage wiring 42 and the second constant voltage wiring 43. The plurality of constant voltage wirings 42 and the plurality of second constant voltage wirings 43 are electrically coupled to the common electrode 52.

The analog signal wiring 44 is disposed outside the constant voltage wiring 42. The second analog signal wiring 45 is wiring different from the analog signal wiring 44 and is disposed outside the second constant voltage wiring 43. Each of the analog signal wiring 44 and the second analog signal wiring 45 transmits the analog signal TH. Two or more of the analog signal wirings 44 may be provided. Similarly, two or more of the second analog signal wirings 45 may be provided.

Each material of the plurality of drive signal wirings 41, the plurality of constant voltage wirings 42, the plurality of second constant voltage wirings 43, the analog signal wiring 44, and the second analog signal wiring 45 is not particularly limited as long as the material is conductive materials, and include, for example, metals such as gold (Au), copper (Cu), titanium (Ti), tungsten (W), nickel (Ni), chromium (Cr), platinum (Pt), and aluminum (Al).

As illustrated in FIGS. 9 to 11, the constant voltage wiring 42 described above is disposed to be interposed between the plurality of drive signal wirings 41 and the analog signal wiring 44 in a direction along the Y axis, which is a "first direction", intersecting with the direction in which the constant voltage wiring 42 is disposed. Since the second analog signal wiring 45 has the same configuration as the analog signal wiring 44, the illustration thereof will be omitted. In addition, hereinafter, the analog signal wiring 44 will be mainly described. The second analog signal wiring 45 exerts the same functions and effects as the analog signal wiring 44.

Each drive signal wiring 41 is wiring for sending the drive signal Vout to the piezoelectric element E. Therefore, noise is likely to be generated around the plurality of drive signal wirings 41. Therefore, when the analog signal wiring 44 is adjacent to the drive signal wiring 41, noise generated from the drive signal wiring 41 is likely to be superimposed on the analog signal wiring 44. In particular, in the present embodiment, whereas a voltage of approximately 43 V is applied to the drive signal wiring 41, a voltage of approximately 3 V is applied to the analog signal wiring 44. Therefore, when the drive signal wiring 41 and the analog signal wiring 44 are adjacent to each other, the analog signal wiring 44 is easily affected by noise from the drive signal wiring 41. On the other hand, in the present embodiment, the constant voltage wiring 42 is disposed between the drive signal wiring 41 and the analog signal wiring 44. Therefore, the constant voltage wiring 42 functions as a shield for noise. Therefore, it is possible to prevent the noise generated from the drive signal wiring 41 from being superimposed on the analog signal wiring 44. Therefore, it is possible to provide a wiring design method that provides high signal transmission accuracy in the analog signal wiring 44.

Similarly, the second constant voltage wiring 43 is disposed to be interposed between the drive signal wiring 41 and the second analog signal wiring 45 in the direction along the Y axis. Therefore, the second constant voltage wiring 43 functions as a shield for noise. Therefore, it is possible to prevent the noise generated from the drive signal wiring 41 from being superimposed on the second analog signal wiring 45.

In the present embodiment, a voltage of approximately 43 V is applied to the drive signal wiring 41, a voltage of approximately 3 V is applied to the analog signal wiring 44 and the second analog signal wiring 45, and a constant voltage of approximately 5 V is applied to the constant voltage wiring 42 and the second constant voltage wiring 43. The present disclosure is not limited thereto. The voltage applied to each wiring is set to any value. In addition, the constant voltage wiring 42 and the second constant voltage wiring 43 may be wirings to which a constant voltage is applied, such as wiring coupled to GND or a power supply voltage used in various configurations.

In addition, the plurality of drive signal wirings 41 are interposed between the constant voltage wiring 42 and the second constant voltage wiring 43 in the direction along the Y axis. Therefore, it is possible to more effectively prevent the influence of the noise generated in the plurality of drive signal wirings 41 on the analog signal wiring 44 and the second analog signal wiring 45.

For example, the second analog signal wiring 45 may not be provided. In this case, the plurality of drive signal wirings 41 may not be interposed between the constant voltage wiring 42 and the second constant voltage wiring 43. In this case, the analog signal wiring 44 may be disposed outside the constant voltage wiring 42.

In addition, the second analog signal wiring 45 may be provided on the same side as the analog signal wiring 44 on the flexible printed substrate 4. In this case, the analog signal wiring 44 and the second analog signal wiring 45 may be disposed outside the constant voltage wiring 42.

In addition, the flexible printed substrate 4 does not have other wirings between an end side 279 of the flexible printed substrate 4 and the analog signal wiring 44 in the direction along the Y axis, that is, the analog signal wiring 44 is provided on the outermost side of the flexible printed substrate 4 in the Y axis. The end side 279 is a side extending along the Y-Z plane in a direction intersecting the extending direction of the first nozzle row La.

By providing the analog signal wiring 44 on the outermost side of the flexible printed substrate 4, it is possible to prevent noise from other wirings from being superimposed on the analog signal wiring 44.

Similarly, the flexible printed substrate 4 does not have other wirings between the end side 279 of the flexible printed substrate 4 and the second analog signal wiring 45 in the direction along the Y axis, that is, the second analog signal wiring 45 is provided on the outermost side of the flexible printed substrate 4 in the Y axis. By providing the second analog signal wiring 45 on the outermost side of the flexible printed substrate 4, it is possible to prevent noise from other wirings from being superimposed on the second analog signal wiring 45.

In addition, a direction of the current flowing through each of the plurality of drive signal wirings 41 is opposite to the direction of a current flowing through the constant voltage wiring 42 and the second constant voltage wiring 43. Therefore, the magnetic field generated from the current flowing through each of the drive signal wirings 41 and the magnetic field generated from the current flowing through the constant voltage wiring 42 and the second constant voltage wiring 43 are in the opposite direction to each other, and thus the magnetic fields cancel each other out. As a result, it is possible to more effectively prevent the noise generated from each drive signal wiring 41 from being superimposed on the analog signal wiring 44 and the second analog signal wiring 45.

In addition, the piezoelectric substrate 30 preferably has 300 or more piezoelectric elements E. The larger the number of piezoelectric elements E, the larger the number of drive signal wirings 41. In this case, the current flowing through the plurality of drive signal wirings 41 increases, and the sum of the noise amounts increases. As a result, noise is likely to be superimposed on the analog signal wiring 44 and the second analog signal wiring 45. Furthermore, since the ON/OFF of the current is set for each drive signal Vout of the piezoelectric element E, noise is randomly generated. Therefore, when a large number of piezoelectric elements E are provided so that the number of piezoelectric elements E is 300 or more, it is particularly beneficial that the constant voltage wiring 42 is disposed between the large number of drive signal wirings 41 and the analog signal wiring 44, and the second constant voltage wiring 43 is disposed between the large number of drive signal wirings 41 and the second analog signal wiring 45.

The number of piezoelectric elements E may be less than 300.

In addition, in the mounting region 271, the width of the analog signal wiring 44 is larger than the width of the constant voltage wiring 42. The width is a width when the flexible printed substrate 4 is viewed in plan view. Since the width of the analog signal wiring 44 is larger than the width of each of the constant voltage wirings 42, it is possible to improve the durability against the stress applied to the flexible printed substrate 4 when the flexible printed substrate 4 is coupled to the piezoelectric substrate 30. By increasing the width of the analog signal wiring 44, which is the region outside the flexible printed substrate 4, the contact area between the analog signal wiring 44 and the piezoelectric substrate 30 is increased. Therefore, the rigidity of the outside of the flexible printed substrate 4 can be increased, and thus it is possible to increase the rigidity of the entire flexible printed substrate 4 in the mounting region 271. Therefore, it is possible to prevent peeling or floating of the flexible printed substrate 4 from the piezoelectric substrate 30, and it is possible to prevent the occurrence of disconnection. In addition, stress can be prevented from being applied to the constant voltage wiring 42 and the plurality of drive signal wirings 41 located inside the analog signal wiring 44.

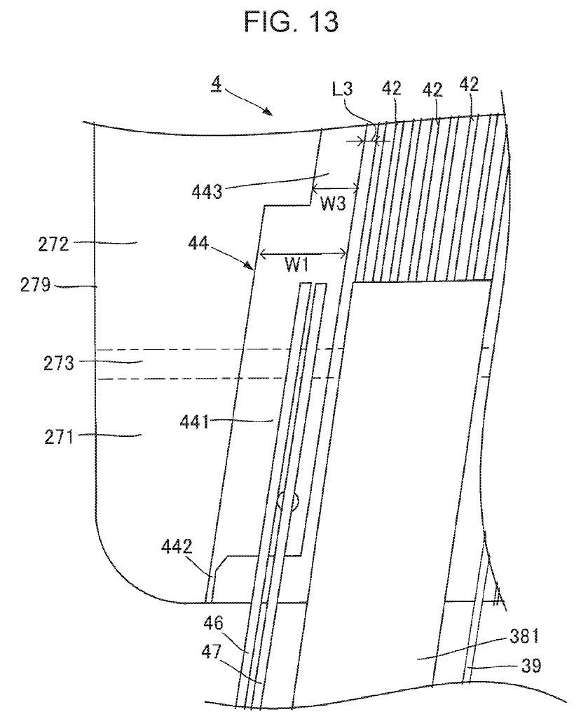

FIG. 12 is a view illustrating the mounting region 271 and the vicinity thereof in a state where the flexible printed substrate 4 illustrated in FIG. 9 is not bent. As illustrated in FIG. 12, the mounting region 271 includes a first region S1, a second region S2, and a third region S3. The first region S1 is a region in which the plurality of drive signal wirings 41 are disposed. The second region S2 is a region in which the analog signal wiring 44 is disposed. The third region S3 is a region in which the constant voltage wiring 42 is disposed. The first region S1, the third region S3, and the second region S2 are arranged in this order along the Y axis. The second region S2 is located on the outermost side on the Y axis.

In addition, the second region S2 is smaller than the first region S1. Since the first region S1 is large, a large number of drive signal wirings 41, for example, 300 or more drive signal wirings 41, can be disposed on the base material 270.

In addition, the planar area of the second region S2 is smaller than the size of the third region S3, that is, the planar area.

In addition, in the non-mounting region 272, the width of the analog signal wiring 44 may be smaller than the width of the constant voltage wiring 42. In this case, since the width of the constant voltage wiring 42 in the non-mounting region 272 is larger than the width of the analog signal wiring 44, it is possible to further prevent the noise generated from the drive signal wiring 41 in the non-mounting region 272 from being superimposed on the analog signal wiring 44.

In addition, the analog signal wiring 44 has a first portion 441 and a second portion 442 in the mounting region 271. The first portion 441 has a first width W1, which is a length along the Y axis. The second portion 442 is located closer to an end portion 2710 of the mounting region 271 than the first portion 441. The end portion 2710 is an end side on the side opposite to the curved portion 273 in the mounting region 271. In addition, the second portion 442 has a second width W2 smaller than the first width W1.

By providing the wide first portion 441, the coupling between the analog signal wiring 44 in the mounting region 271 and the piezoelectric substrate 30 can be more reliably performed. In particular, the analog signal wiring 44 is located on the outermost side in the direction along the Y axis of the flexible printed substrate 4, and is likely to be affected by the positional displacement when the flexible printed substrate 4 is mounted, or the peeling or floating of the flexible printed substrate 4. By providing the wide first portion 441, the coupling can be more reliably performed even when a positional displacement occurs. In addition, since the coupling can be more reliably performed, the contact resistance generated in the first portion 441 can be reduced.

In addition, by making the second width W2 of the second portion 442 smaller than the first width W1 of the first portion 441, the material of the second portion 442 can be reduced.

The first portion 441 and the second portion 442 may have the same width.

In addition, the constant voltage wiring 42 is exposed to the outside at the end portion 2710, which is the side surface of one end portion of the flexible printed substrate 4. Similarly, the second portion 442 of the analog signal wiring 44 is exposed to the outside at the end portion 2710. In the direction along the Y axis, a distance L2 between the second portion 442 and the constant voltage wiring 42 is larger than a distance L1 between the first portion 441 and the constant voltage wiring 42.

The end portion 2710 of the flexible printed substrate 4 is formed by disposing the analog signal wiring 44 on the base material 270 and cutting the base material 270 after the inspection of the step is completed. In this case, a part of the analog signal wiring 44 may be exposed, and a burr may be generated at the end portion 2710, which is a cut surface. Various wirings such as the analog signal wiring 44 contain a metal such as Cu, and are easily oxidized. Therefore, when the oxide film is formed on the burr and the formation of the oxide film proceeds, there is a possibility that a part of the analog signal wiring 44 and the constant voltage wiring 42 are electrically coupled to each other. Therefore, by increasing the distance between the second portion 442 of the analog signal wiring 44 and the constant voltage wiring 42, the possibility of electrical coupling as described above can be prevented.

On the other hand, since no burr is generated in the first portion 441, there is no possibility that the first portion 441 and the constant voltage wiring 42 are electrically coupled to each other. Therefore, by making the distance L1 between the first portion 441 and the constant voltage wiring 42 smaller than the distance L2, the distance between the analog signal wiring 44 and the constant voltage wiring 42 can be shortened, and the flexible printed substrate 4 can be miniaturized.

The distance L2 between the second portion 442 and the constant voltage wiring 42 may be equal to or less than the distance L1 between the first portion 441 and the constant voltage wiring 42.

Furthermore, the analog signal wiring 44 includes a third portion 443. The third portion 443 is coupled to the first portion 441. The third portion 443 has a third width W3 smaller than the first width W1 of the first portion 441. The third width W3 is larger than the width W20 of the constant voltage wiring 42. The third width W3 is larger than the second width W2.

By making the width of the first portion 441 located in the mounting region 271 larger than the width of the third portion 443 located in the non-mounting region 272, it is possible to prevent disconnection when peeling or floating of various wirings from the base material 270 occurs in the mounting region 271. In addition, by making the third portion 443 thinner than the first portion 441 located in the mounting region 271, the material of the analog signal wiring 44 can be reduced. In addition, since the third width W3 of the third portion 443 located outside the constant voltage wiring 42 is larger than the third width W3 of the constant voltage wiring 42, the durability of the flexible printed substrate 4 can be improved.

The third width W3 of the third portion 443 may be equal to or larger than the first width W1 of the first portion 441. In addition, the third width W3 of the third portion may be equal to or less than the width of the constant voltage wiring 42.

In addition, in the direction along the Y axis, the second portion 442 and the third portion 443 are asymmetrically disposed with respect to the first portion 441. Specifically, the first portion 441 has a quadrangular shape in plan view in a state where the flexible printed substrate 4 is not bent. The second portion 442 is coupled to one corner portion of the first portion 441, and the third portion 443 is coupled to a corner portion of the first portion 441 facing the one corner portion. The distance L3 between the third portion 443 and the constant voltage wiring 42 is smaller than the distance L2 between the second portion 442 and the constant voltage wiring 42. The flexible printed substrate 4 can be miniaturized by shortening the distance L3 between the third portion 443 and the constant voltage wiring 42. In addition, by increasing the distance L2 between the second portion 442 and the constant voltage wiring 42, it is possible to prevent the second portion 442 and the constant voltage wiring 42 from being electrically coupled to each other outside.

The distance L3 between the third portion 443 and the constant voltage wiring 42 may be equal to or larger than the distance L2 between the second portion 442 and the constant voltage wiring 42.

In addition, the first portion 441 is provided over the curved portion 273. Therefore, the first portion 441 extends from the mounting region 271 to the outside of the mounting region 271. In the present embodiment, the first portion 441 having a large area is located in the curved portion, instead of the second portion 442 and the third portion 443. Therefore, the rigidity of the flexible printed substrate 4 can be ensured when the flexible printed substrate 4 is bent. In addition, the presence of the first portion 441 can prevent a bending return when being bent

The first portion 441 is not provided with a material constituting the analog signal wiring 44, and includes an opening portion 44H provided in the analog signal wiring 44. The opening portion 44H functions as an alignment mark used for positioning when the flexible printed substrate 4 is mounted on the piezoelectric substrate 30. By providing the opening portion 44H, which is an alignment mark, in the analog signal wiring 44, the entire flexible printed substrate 4 can be miniaturized as compared with a configuration in which the opening portion 44H is separately provided at a location other than the analog signal wiring 44.

The opening portion 44H is a hole penetrating the analog signal wiring 44 and does not penetrate the base material 270. However, the opening portion 44H may further penetrate the base material 270, in addition to the analog signal wiring 44. The alignment mark may be provided in a portion of the base material 270 in which various wirings are not provided.

In addition, as illustrated in FIG. 9, the base material 270 is provided with two identification marks 2701 and two through-holes 270H. Each identification mark 2701 is a thin film containing metal, and is circular in the example illustrated in the drawing. For example, each identification mark 2701 is provided to identify the flexible printed substrate 4. The two through-holes 270H are provided in correspondence with the two identification marks 2701 on a one-to-one basis. A corresponding through-hole 270H is provided below each identification mark 2701.

Each through-hole 270H is a hole penetrating the flexible printed substrate 4. For example, each of the through-holes 270H is provided for positioning between the flexible printed substrate 4 and another member. In addition, a part of the analog signal wiring 44 is disposed so as to surround one of the two through-holes 270H. The second analog signal wiring 45 is disposed so as to surround the other of the two through-holes 270H.

When the analog signal wiring 44 is disposed around one through-hole 270H, the rigidity around the through-hole 270H can be increased. When the analog signal wiring 44 is made of metal plating, the periphery of the through-hole 270H is surrounded by the metal plating by providing the analog signal wiring 44 around the through-hole 270H, so that it is possible to prevent corrosion. Since the second analog signal wiring 45 is also provided for the other through-hole 270H, the same effect as described above can be obtained.

The two identification marks 2701 and the two through-holes 270H may be omitted as appropriate.

In addition, as illustrated in FIG. 8, a first resistance wiring 46 and a second resistance wiring 47 are provided on a surface of the piezoelectric substrate 30 facing the Z2 direction. The first resistance wiring 46 is provided along the first nozzle row La in plan view. The second resistance wiring 47 is provided along the second nozzle row Lb in plan view. In addition, in the present embodiment, one end of the first resistance wiring 46 and one end of the second resistance wiring 47 are coupled to the analog signal wiring 44. In addition, the other end of the first resistance wiring 46 and the other end of the second resistance wiring 47 are coupled to the second analog signal wiring 45. Therefore, the first resistance wiring 46 and the second resistance wiring 47 are coupled in parallel.

Since the first resistance wiring 46 and the second resistance wiring 47 are coupled in parallel, it is possible to reduce the resistance as compared with a case where the first resistance wiring 46 and the second resistance wiring 47 are coupled in series. Therefore, the analog signal TH can be acquired with low power. In addition, since the first resistance wiring 46 is provided along the first nozzle row La and the second resistance wiring 47 is provided along the second nozzle row Lb, average information of the first nozzle row La and the second nozzle row Lb can be acquired.

Each of the first resistance wiring 46 and the second resistance wiring 47 may be disposed in a part of the nozzle row. In addition, different resistance wirings may be provided, in addition to the first resistance wiring 46 and the second resistance wiring 47.

In addition, the analog signal wiring 44 and the second analog signal wiring 45 are electrically coupled to the analog signal detection circuit 22 provided on the flexible printed substrate 4. When the analog signal detection circuit 22 is a “temperature detection portion”, the ejection control of the liquid ejecting module 20 suitable for the temperature of the ink in the pressure chamber C1 can be performed using the analog signal TH. In addition, the ejection characteristic is likely to change with temperature. Therefore, it is preferable that the analog signal detection circuit 22 can detect a minute change in temperature. According to the present embodiment, since the constant voltage wiring 42 is disposed between the drive signal wiring 41 and the analog signal wiring 44, it is possible to prevent the noise generated from the drive signal wiring 41 from being superimposed on the analog signal wiring 44. Similarly, since the second constant voltage wiring 43 is disposed between the drive signal wiring 41 and the second analog signal wiring 45, it is possible to prevent the noise generated from the drive signal wiring 41 from being superimposed on the second analog signal wiring 45. Therefore, it is possible to detect a minute change in temperature based on the signal output from the analog signal detection circuit 22.

The resistance value of the first resistance wiring 46 is likely to change in accordance with the temperature change of the plurality of pressure chambers C1 corresponding to the first nozzle row La. The resistance value of the second resistance wiring 47 is likely to change in accordance with the temperature change of the plurality of pressure chambers C1 corresponding to the second nozzle row Lb. When the analog signal detection circuit 22 is a “temperature detection portion”, the analog signal detection circuit 22 outputs the analog signal TH related to the resistance values of the first resistance wiring 46 and the second resistance wiring 47 as the physical information signal TI related to the temperature.

In addition, each of the first resistance wiring 46 and the second resistance wiring 47 is arranged in a zigzag shape so as to reciprocate a plurality of times along the Y axis. Therefore, since the wiring lengths of the first resistance wiring 46 and the second resistance wiring 47 are increased, the resistance of the first resistance wiring 46 and the second resistance wiring 47 can be increased.

In addition, in the mounting region 271, the width of each of the first resistance wiring 46 and the second resistance wiring 47 is smaller than the width of the first portion 441 of the analog signal wiring 44. By setting such a wiring width, the resistance value of each of the first resistance wiring 46 and the second resistance wiring 47 can be made larger than the value of the other resistance existing on the detection circuit, for example, the contact resistance.

Since the analog signal wiring 44 is located on the outermost side in the direction along the Y axis of the flexible printed substrate 4, the analog signal wiring 44 is likely to be affected by positional displacement, peeling, or floating in the mounting region when the flexible printed substrate 4 is mounted. In addition, since the wiring widths of the first resistance wiring 46 and the second resistance wiring 47 are reduced in order to increase the resistance, when the positional displacement, peeling, or floating occurs in the mounting region 271, there is a possibility that the contact resistance between the analog signal wiring 44, the first resistance wiring 46, and the second resistance wiring 47 may increase.

FIG. 13 is a view illustrating a coupling state between various wirings provided in the flexible printed substrate illustrated in FIG. 9 and various electrodes provided in the piezoelectric substrate 30. As illustrated in FIG. 13, in the present embodiment, the first width W1 of the first portion 441 of the analog signal wiring 44 in the mounting region 271 is larger than the widths of the other analog signal wirings 44 and is larger than the widths of the first resistance wiring 46 and the second resistance wiring 47. Therefore, the coupling between the analog signal wiring 44, the first resistance wiring 46, and the second resistance wiring 47 is more reliably performed, and thus it is possible to prevent the occurrence of a coupling failure. As a result, the contact resistance between the analog signal wiring 44, the first resistance wiring 46, and the second resistance wiring 47 can be reduced.

As described above, the contact resistance between the analog signal wiring 44, the first resistance wiring 46, and the second resistance wiring 47 can be reduced while the resistance of the first resistance wiring 46 and the second resistance wiring 47 is increased. Therefore, the change in the resistance value of the first resistance wiring 46 and the second resistance wiring 47 can be detected with higher accuracy. Therefore, the amount of change in temperature of the first nozzle row La and the second nozzle row Lb can be detected with higher accuracy.

In addition, in the present embodiment, it is also possible to prevent the variation in the contact resistance between the plurality of liquid ejecting modules 20. When the values of the contact resistance are different between the plurality of liquid ejecting modules, it is necessary to perform calibration for correcting an error in the detection value caused due to the variation in the contact resistance. In the present embodiment, since the influence of the contact resistance can be reduced, the calibration can be performed without any trouble.

### 2. Modification Example

The embodiments described above may be modified in various ways. A specific modification aspect that can be applied to the embodiments described above will be described below. Two or more aspects randomly selected from the following examples can be appropriately merged to the extent that these aspects do not contradict each other.

### 2-1. First Modification Example

The first resistance wiring 46 is coupled to the analog signal wiring 44 and the second analog signal wiring 45. On the other hand, the second resistance wiring 47 is not coupled to the analog signal wiring 44 and the second analog signal wiring 45. At this time, the second resistance wiring 47 is coupled to an analog signal wiring different from the analog signal wiring 44 and the second analog signal wiring 45.

In the present modification example, one resistance wiring is coupled to one analog signal wiring. Therefore, it is possible to detect the amount of change in temperature of any of the first nozzle row La and the second nozzle row Lb.

The second resistance wiring 47 may not be coupled to the analog signal wiring 44 and the second analog signal wiring 45, and may be coupled to, for example, the constant voltage wiring 42 or the second constant voltage wiring 43.

### 2-2. Other Modification Examples

In the embodiment, the first resistance wiring 46 and the second resistance wiring 47 are provided for detecting the change in the ink temperature in the pressure chamber C1, and the present disclosure is not limited thereto. For example, the first resistance wiring 46 and the second resistance wiring 47 may be wirings for detecting the temperature or humidity of the liquid ejecting module 20 other than the pressure chamber C1, the temperature or humidity in the vicinity of the liquid ejecting module 20, or the pressure of the ink in the vicinity of the pressure chamber C1.

The "liquid ejecting head" may be a circulation type head having a so-called circulation flow path.

The "liquid ejecting apparatus" can be adopted in various devices, such as a facsimile machine and a copying machine, in addition to a device dedicated to printing. Use of the liquid ejecting apparatus is not limited to printing. For example, a liquid ejecting apparatus that ejects a solution of a coloring material is used as a manufacturing apparatus that forms a color filter of a display device such as a liquid crystal display panel. In addition, a liquid ejecting apparatus that ejects a solution of a conductive material is used as a manufacturing apparatus for forming wiring and electrodes on a wiring substrate. In addition, a liquid ejecting apparatus that ejects a solution of an organic substance related to a living body is used as a manufacturing apparatus for manufacturing a biochip, for example.

Although the present disclosure is described above based on the preferred embodiments, the present disclosure is not limited to the above-described embodiments. In addition, the configuration of each portion of the present disclosure can be replaced with any configuration having the same function in the above-described embodiments, and any configuration can be added.

What is claimed is:

1. A liquid ejecting head comprising:
a piezoelectric substrate that includes a plurality of piezoelectric elements;
a wiring substrate; and
a flexible printed substrate configured to electrically couple the piezoelectric substrate and the wiring substrate, wherein
the flexible printed substrate includes
a plurality of drive signal wirings configured to transmit drive signals for driving the plurality of piezoelectric elements,
an analog signal wiring configured to transmit an analog signal, and
a constant voltage wiring maintained at a constant voltage, and
the constant voltage wiring is interposed between the drive signal wiring and the analog signal wiring in a first direction intersecting with a direction in which the constant voltage wiring is disposed.

2. The liquid ejecting head according to claim 1, wherein
the flexible printed substrate includes a second constant voltage wiring maintained at a constant voltage and different from the constant voltage wiring, and
in the first direction, the plurality of drive signal wirings are interposed between the constant voltage wiring and the second constant voltage wiring.

3. The liquid ejecting head according to claim 2, wherein
the flexible printed substrate does not have a wiring between an end side of the flexible printed substrate and the analog signal wiring in the first direction.

4. The liquid ejecting head according to claim 1, wherein
the piezoelectric substrate includes a plurality of piezoelectric portions, a common electrode provided commonly to the plurality of piezoelectric portions, and a plurality of individual electrodes provided to correspond to the plurality of piezoelectric portions,
the plurality of drive signal wirings are electrically coupled to the plurality of individual electrodes on a one-to-one basis,
the constant voltage wiring is electrically coupled to the common electrode, and
a direction of a current flowing through each of the plurality of drive signal wirings is opposite to a direction of a current flowing through the constant voltage wiring.

5. The liquid ejecting head according to claim 1, wherein
in the flexible printed substrate, a region where the plurality of drive signal wirings, the analog signal wiring, and the constant voltage wiring are coupled to the piezoelectric substrate is set as a mounting region, and
in the mounting region, a width of the analog signal wiring is larger than a width of the constant voltage wiring.

6. The liquid ejecting head according to claim 5, wherein
in a non-mounting region different from the mounting region on the flexible printed substrate, the width of the constant voltage wiring is larger than the width of the analog signal wiring.

7. The liquid ejecting head according to claim 1, wherein
the piezoelectric substrate includes 300 or more piezoelectric elements, and
the plurality of drive signal wirings are electrically coupled to the 300 or more piezoelectric elements.

8. The liquid ejecting head according to claim 1, wherein
in the flexible printed substrate, a region where the plurality of drive signal wirings, the analog signal wiring, and the constant voltage wiring are coupled to the piezoelectric substrate is set as a mounting region, and
the analog signal wiring includes, in the mounting region,
a first portion having a first width, and
a second portion located at an end portion of the mounting region with respect to the first portion and having a second width smaller than the first width.

9. The liquid ejecting head according to claim 8, wherein
the constant voltage wiring is exposed to an outside at one end portion of the flexible printed substrate,
the second portion of the analog signal wiring is exposed to the outside at the one end portion, and
in the first direction, a distance between the second portion and the constant voltage wiring is larger than a distance between the first portion and the constant voltage wiring.

10. The liquid ejecting head according to claim 9, wherein
the analog signal wiring includes a third portion coupled to the first portion and having a smaller width than the first portion and a larger width than the constant voltage wiring.

11. The liquid ejecting head according to claim 10, wherein
in the first direction, a distance between the third portion and the constant voltage wiring is smaller than a distance between the second portion and the constant voltage wiring.

12. The liquid ejecting head according to claim 8, wherein
the first portion extends to an outside of the mounting region.

13. The liquid ejecting head according to claim 8, wherein
the first portion is not provided with a material constituting the analog signal wiring, and includes an opening portion provided in the analog signal wiring.

14. The liquid ejecting head according to claim 1, wherein
the analog signal wiring is disposed to surround a through-hole penetrating the flexible printed substrate.

15. The liquid ejecting head according to claim 1, further comprising:
a nozzle substrate that includes a first nozzle row, and a second nozzle row arranged in parallel in a direction along the first nozzle row;
a first resistance wiring provided along the first nozzle row; and
a second resistance wiring provided along the second nozzle row, wherein
the first resistance wiring and the second resistance wiring are coupled to the analog signal wiring.

16. The liquid ejecting head according to claim 1, further comprising:
a nozzle substrate that includes a first nozzle row, and a second nozzle row arranged in parallel in a direction along the first nozzle row;
a first resistance wiring provided along the first nozzle row; and
a second resistance wiring provided along the second nozzle row, wherein
the first resistance wiring is coupled to the analog signal wiring, and
the second resistance wiring is not coupled to the analog signal wiring.

17. The liquid ejecting head according to claim 1, further comprising:
a pressure chamber substrate coupled to the piezoelectric substrate and provided with a pressure chamber whose volume changes in response to deformation of the piezoelectric substrate, wherein
the piezoelectric substrate includes a temperature detection portion configured to detect a temperature of the pressure chamber, and
the analog signal wiring is electrically coupled to the temperature detection portion.
